(19) United States
(12) Patent Application Publication
(10) Pub. No.: US 2011/0200713 A1
(43) Pub. Date: Aug. 18, 2011

(54) PERFORATED STIRRER

(76) Inventors: Anthony Simone, Derby, CT (US); Mario Elcuri, Hamden, CT (US)

(21) Appl. No.: 13/021,109

(22) Filed: Feb. 4, 2011

Related U.S. Application Data
(60) Provisional application No. 61/303,757, filed on Feb. 12, 2010.

(51) Int. Cl. B65B 29/02; A23F 5/00; A23F 3/00

(52) U.S. Cl. 426/78; 426/82; 426/442; 426/594; 426/597

(57) ABSTRACT

A perforated stirrer contains a drink product requiring mixing upon use; examples of such products include tea, instant coffee, powdered lemonade, etc. The stirrer may also contain additional mixing ingredients (e.g. sugar or powdered milk). A stirrer according to the disclosure thus provides both the ingredients for making the beverage and an implement for stirring the beverage.

### CROSS-REFERENCE TO RELATED APPLICATIONS

This application claims the priority benefit of U.S. Provisional Application No. 61/303,757 filed Feb. 12, 2010, the entire disclosure of which is incorporated herein by reference.

### FIELD OF THE DISCLOSURE

This disclosure relates generally to producing and stirring mixtures in liquids. More particularly, the disclosure relates to making beverages such as coffee, and specifically to stirring and mixing an instant beverage and condiments (sugar, creamer and the like) for a serving of the beverage.

### BACKGROUND OF THE DISCLOSURE

A person making a cup of coffee or tea to his/her liking must often contend with separate dispensers or containers for coffee or tea, sugar and creamer, and also needs an implement for stirring the finished product. In a typical fast-food setting, the sugar and creamer are supplied in small packets, and a separate stirrer is used. The opened packaging and stirrer must be disposed after use. Often this leaves the table area untidy.

### SUMMARY OF THE DISCLOSURE

The present disclosure provides a perforated stirrer containing a drink product requiring mixing upon use; examples of such products include tea, instant coffee, powdered lemonade, etc. The stirrer may also contain additional mixing ingredients (e.g. sugar or powdered milk). A stirrer according to the disclosure thus provides both the ingredients for making the beverage and an implement for stirring the beverage.

According to an aspect of the disclosure, an apparatus for making and stirring a liquid mixture includes a stirrer having an exterior wall with a perforation formed in at least a portion thereof, and at least one container disposed in the interior of the stirrer and configured to contain a mixture component. The container is formed of a material permitting the liquid to contact the mixture component; immersion of the perforated portion of the stirrer in the liquid causes the liquid to contact the container through the perforation, thereby producing a mixture of the liquid and the component external to the stirrer.

According to another aspect of the disclosure, an apparatus for making and stirring a liquid mixture includes a stirrer having an exterior wall with a perforation formed in at least a portion thereof, and at least one solid divider disposed in the interior of the stirrer dividing at least a portion of the interior of the stirrer into compartments. At least one compartment contains a mixture component. The apparatus also includes a covering disposed on the exterior wall of the stirrer and covering the perforated portion of the stirrer; the material of the covering dissolves on contact with the liquid, thereby permitting the component to dissolve in the liquid and produce a mixture of the liquid and component external to the stirrer.

According to another aspect of the disclosure, a method for preparing a liquid mixture includes the steps of providing a stirrer as described above; and immersing the perforated portion of the stirrer in the liquid, to cause the liquid to contact the container through the perforation and thereby produce a mixture of the liquid and the component.

The foregoing has outlined, rather broadly, the preferred features of the present disclosure so that those skilled in the art may better understand the detailed description of the disclosure that follows. Additional features of the disclosure will be described hereinafter that form the subject of the claims of the disclosure. Those skilled in the art should appreciate that they can readily use the disclosed conception and specific embodiment as a basis for designing or modifying other structures for carrying out the same purposes of the present disclosure and that such other structures do not depart from the spirit and scope of the disclosure in its broadest form.

### BRIEF DESCRIPTION OF THE DRAWINGS

FIG. 1A illustrates a perforated stirrer with a product contained therein, according to an embodiment of the disclosure.

FIG. 1B is an isolation view of the container for the product of FIG. 1A.

FIG. 1C is an end view of the perforated stirrer of FIG. 1A.

FIG. 2A illustrates a paddle-shaped stirrer with a product contained therein, according to another embodiment of the disclosure.

FIG. 2B is an isolation view of the container for the product of FIG. 2A.

FIG. 2C is an end view of the stirrer of FIG. 2A.

FIG. 3A illustrates a perforated stirrer with a plurality of product containers contained therein, according to a further embodiment of the disclosure.

FIG. 3B illustrates the containers for the products of FIG. 3A.

FIG. 3C is an end view of the perforated stirrer of FIG. 3A.

FIG. 4 illustrates a perforated stirrer with a plurality of separate compartments for holding products, according to an additional embodiment of the disclosure.

### DETAILED DESCRIPTION

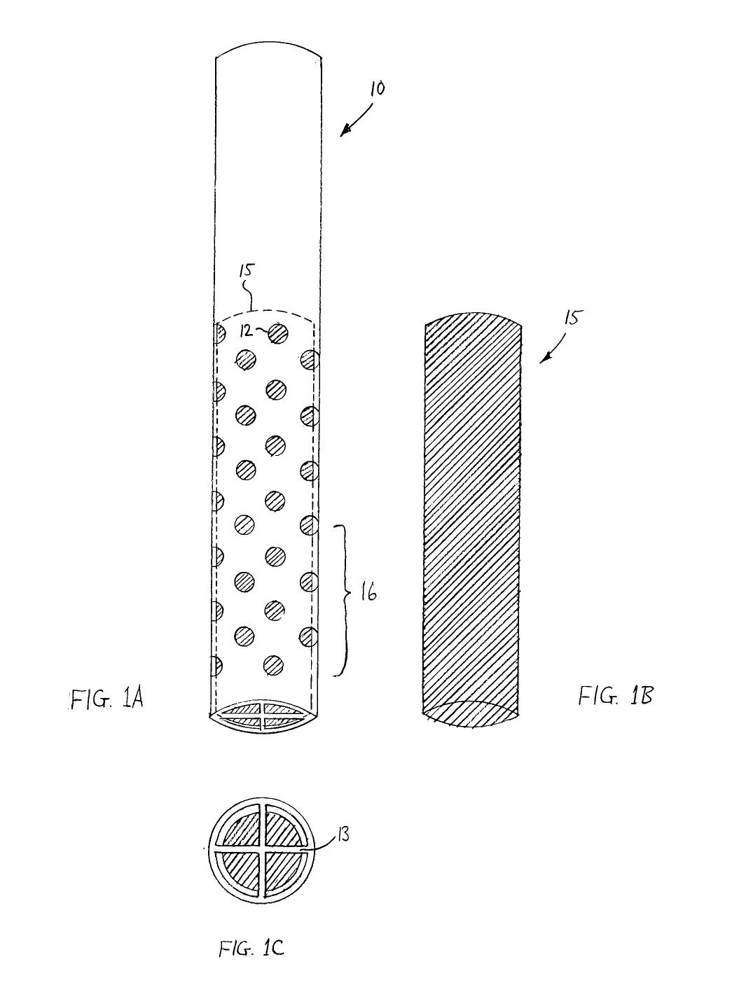

A stirrer for providing a single product (e.g. hot coffee or tea), according to an embodiment of the disclosure, is shown in FIG. 1A. Stirrer 10 is a hollow cylinder having a plurality of holes 12 formed therein, at least in a region 16 near one end which is to be immersed in liquid. A container 15 for the product (e.g. an instant beverage) is disposed inside the cylinder. As shown in FIG. 1B, container 15 has a diameter and a length to conform to the inside diameter and the length of the perforated portion of the cylinder. Container 15 has a paper or mesh exterior permeable by the surrounding liquid (as is typical of a tea bag, for example). Alternatively, container 15 may be made of a dissolvable film, so that both the container and the contents thereof dissolve into the surrounding liquid. Container 15 may be filled with tea, instant coffee, powdered cocoa, powdered bouillon, powdered lemonade, etc.

Stirring the liquid with the stirrer 10 causes the liquid to flow through holes 12 and permeate container 15, come into contact with the contents of the container, and thus produce the desired beverage. Depending on the beverage desired, the liquid may be hot water (e.g. for bouillon), hot milk (e.g. for cocoa), cold water (e.g. for lemonade), etc. In this embodiment, as shown in FIG. 1C, the end of stirrer 10 has a grid structure 13 permitting liquid to flow into the cylinder while supporting container 15 inside the cylinder.

Stirrer 10 is typically made of plastic, but may be of any material suitable for food service and immersible in liquid of the desired temperature (typically boiling water).

In this embodiment, the holes 12 in the cylinder are circular and are located in a portion of the cylinder. In general, the holes may be of any desired shape or size, and may perforate part or all of the length of the cylinder. In addition, the size of the holes may be selected according to the dissolving rate of the product; for example, a slowly dissolving or infusing product may be advantageously contained in a stirrer with relatively large holes.

In this embodiment, the stirrer is a circular cylinder, but may be another shape if desired (e.g. a square cylinder, a triangular cylinder, a hollow spiral shape, etc.).

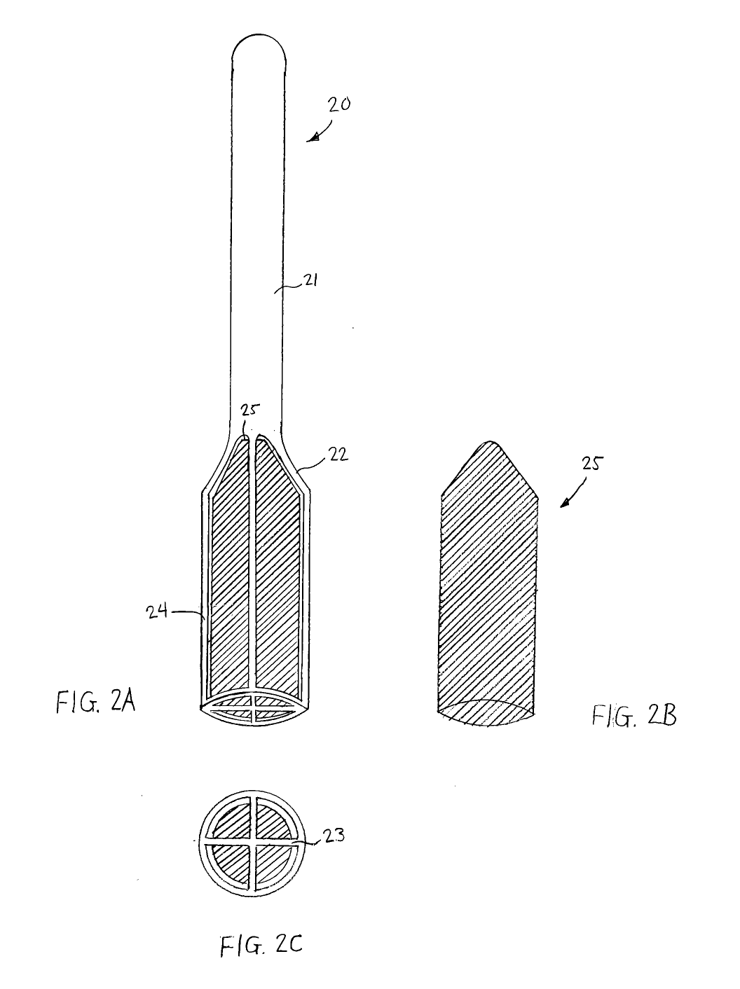

FIG. 2A illustrates a paddle-shaped stirrer according to another embodiment of the disclosure. Stirrer 20 has a handle portion 21 and a product stirring portion 22, which holds product container 25. Stirring portion 22 has a cage structure 24 for holding the container 25, while permitting liquid to permeate the container. As shown in FIG. 2B, container 25 has a size and shape conforming to the interior of stirring portion 22. In this embodiment, as shown in FIG. 2C, the end of stirrer 20 has a grid structure 23 permitting liquid to flow into the stirrer while supporting container 25 therein. Container 25 is constructed and holds a product similarly to container 15. The shape of stirrer 20 may be modified as desired; for example, product stirring portion 22 may have a spoon shape and handle portion 21 may be shaped as a spoon handle.

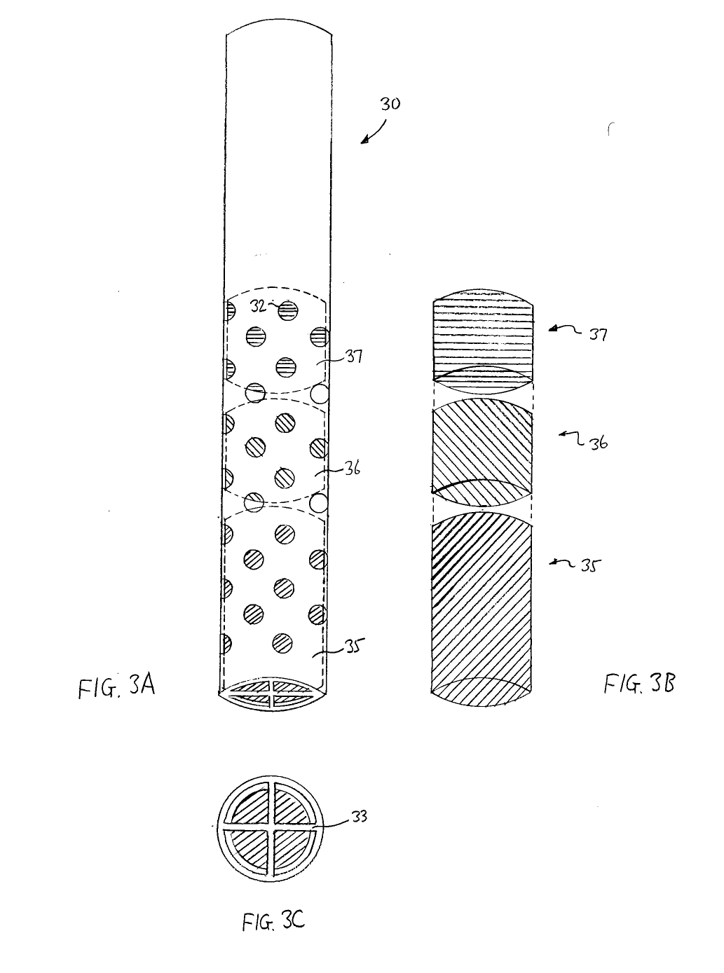

In another embodiment, shown in FIG. 3A, a stirrer 30 is perforated with holes 32 and has a plurality of containers 35, 36, 37 disposed within the stirrer. The containers have separate products for mixing together in the desired beverage. For example, container 35 may be a mesh or paper bag as described above, containing tea or instant coffee. Containers 36 and 37 may be formed of a dissolvable film and hold powdered creamer and sweetener, respectively (FIG. 3B). Accordingly, when the perforated end of stirrer 30 is immersed in a cup of hot water, water flows through the perforations and permeates container 35 while dissolving the film of containers 36 and 37; this produces a cup of coffee with creamer and sweetener dissolved in the coffee. The user may continue to stir the stirrer 30 until the coffee reaches the desired strength. It is desirable that when container 35 holds tea, the container not be made of a dissolvable film so that tea leaves are confined to the container. If container 35 holds a dissolvable product such as instant coffee, bouillon, powdered lemonade, etc., the container may be made of a dissolvable film similarly to containers 36 and/or 37. In this embodiment, as shown in FIG. 3C, the end of stirrer 30 has a grid structure 33 permitting liquid to flow into the cylinder while supporting containers 35-37 inside the cylinder.

A stirrer embodying the disclosure may also be used to add a controlled amount of a product to a liquid already prepared. For example, a user stirring a soup, gravy, etc. (prepared by some other means) may use a stirrer as described above to add herbs, seasonings, spices, flavorings, colorings or the like. The container for the herbs, etc. (for example, container 15) may be formed of a paper or mesh material (in which case the added product is infused into the surrounding liquid), or may be formed of a dissolvable material (in which case the product comes into contact with liquid entering through the holes 12 and dissolves in the surrounding liquid).

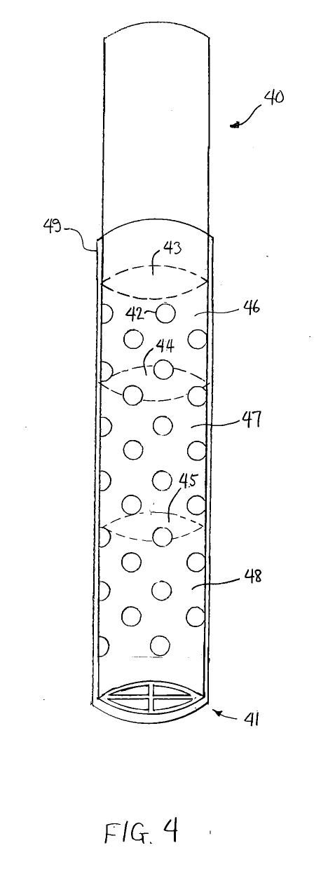

In another embodiment, shown in FIG. 4, products to be dissolved in the liquid are not individually packaged, but are disposed in separate compartments in the stirrer. Stirrer 40 is a perforated cylinder as described above, including an end 41 with a grid structure and holes 42. Stirrer 40 also has solid dividers 43, 44, 45 which divide the interior of the stirrer into compartments 46, 47, 48. In this embodiment, a different dissolvable product is disposed in each compartment (e.g. instant coffee, powdered creamer, and sugar respectively). A sleeve 49 of a dissolvable material encases end 41, covers the holes 42, and is adhered to the upper portion of stirrer 40, thereby retaining the products in their respective compartments until the stirrer is immersed in liquid. In an embodiment, when a user dips the stirrer into hot water, film 49 dissolves so that instant coffee in compartment 48, creamer in compartment 47, and sugar in compartment 46 come into contact with the water. These different components then dissolve in the water to produce the desired beverage; the user stirs the beverage until the desired strength is obtained.

It will be appreciated that a stirrer according to the disclosure may be used to produce mixtures of various components; the disclosure is not limited to stirrers for preparing beverages. For example, stirrer 10 may have a container 15 filled with a chemical agent which is to be mixed with a liquid (typically but not necessarily water). In another example, stirrer 10 may have a container 15 filled with a powdered colorant; when the stirrer is used to stir a paint base, the colorant is released into the base. The user continues to stir the paint until the desired hue is obtained.

While the disclosure has been described in terms of specific embodiments, it is evident in view of the foregoing description that numerous alternatives, modifications and variations will be apparent to those skilled in the art. Accordingly, the disclosure is intended to encompass all such alternatives, modifications and variations which fall within the scope and spirit of the disclosure and the following claims.

We claim:

1. An apparatus for making and stirring a liquid mixture, comprising:
a stirrer having an exterior wall with a perforation formed in at least a portion thereof;
at least one container disposed in the interior of the stirrer and configured to contain a mixture component, the container formed of a material permitting the liquid to contact said component,
wherein immersion of the perforated portion of the stirrer in the liquid causes the liquid to contact the container through the perforation, thereby producing a mixture of the liquid and the component external to the stirrer.

2. An apparatus according to claim 1, wherein the stirrer is a hollow cylinder having a plurality of perforations.

3. An apparatus according to claim 2, wherein an end of the cylinder at said perforated portion has a structure integral with the exterior wall with an opening therein, the structure effective to hold the container within the cylinder and the opening permitting the liquid to contact the container.

4. An apparatus according to claim 2, wherein the container has a length corresponding to the length of the perforated portion of the cylinder.

5. An apparatus according to claim 1, wherein the material of the container permits infusion of the component into the liquid.

6. An apparatus according to claim 5, wherein the component has an infusion rate with respect to the liquid, and the perforation has a size in accordance with the infusion rate.

7. An apparatus according to claim 1, wherein the material of the container dissolves on contact with the liquid, thereby permitting said component to dissolve in the liquid.

8. An apparatus according to claim 1, wherein the stirrer includes a solid handle portion and a perforated hollow portion with the container disposed in the perforated hollow portion.

9. An apparatus according to claim 1, wherein the liquid is water and said component is a component of a desired beverage.

10. An apparatus according to claim 1, wherein
the stirrer has a plurality of perforations, and
the stirrer has a plurality of containers disposed therein, each container including a different component.

11. An apparatus according to claim 10, wherein
the liquid is water,
a first container contains coffee or tea, and
at least one other container contains creamer or sweetener.

12. An apparatus according to claim 1, wherein the container contains an herb, seasoning, spice, flavoring and/or coloring for addition to the mixture.

13. An apparatus for making and stirring a liquid mixture, comprising:
a stirrer having an exterior wall with a perforation formed in at least a portion thereof;
at least one solid divider disposed in the interior of the stirrer dividing at least a portion of the interior of the stirrer into compartments, at least one compartment containing a mixture component;
a covering disposed on the exterior wall of the stirrer and covering the perforated portion of the stirrer, wherein the material of the covering dissolves on contact with the liquid, thereby permitting said component to dissolve in the liquid and produce a mixture of the liquid and the component external to the stirrer.

14. An apparatus according to claim 13, wherein the stirrer is a hollow cylinder having a plurality of perforations.

15. An apparatus according to claim 14, wherein an end of the cylinder at said perforated portion has a structure integral with the exterior wall with an opening therein.

16. An apparatus according to claim 13, wherein
the stirrer has a plurality of perforations, and
the stirrer has a plurality of compartments each containing a different component, each said compartment having at least one perforation.

17. An apparatus according to claim 15, wherein
the liquid is water,
a first compartment contains coffee or tea, and
at least one other compartment contains creamer or sweetener.

18. A method for preparing a liquid mixture, comprising the steps of:
providing a stirrer having an exterior wall with a perforation formed in at least a portion thereof and at least one container disposed in the interior of the stirrer and configured to contain a mixture component, the container formed of a material permitting the liquid to contact said component;
immersing the perforated portion of the stirrer in the liquid to cause the liquid to contact the container through the perforation, thereby producing a mixture of the liquid and the component external to the stirrer.

19. A method according to claim 18, wherein the stirrer is a hollow cylinder having a plurality of perforations.

20. A method according to claim 19, wherein
the stirrer has a plurality of containers disposed therein, each container including a different component,
the liquid is water,
a first container contains coffee or tea, and
at least one other container contains creamer or sweetener.
